(19) United States
(12) Patent Application Publication
(10) Pub. No.: US 2010/0088377 A1
(43) Pub. Date: Apr. 8, 2010

(54) SYSTEM AND METHOD FOR EMAIL THREAD MANAGEMENT

(76) Inventors: Sandra K. Johnson, Cary, NC (US); Ingrid M. Moulckers, Austin, TX (US); Ben Himmel, Yorktown Heights, NY (US); Maria Azua, Yorktown Heights, NY (US)

Correspondence Address: HOLLAND & KNIGHT, 10 ST. JAMES AVENUE, BOSTON, MA, 02116-3889, US

(21) Appl. No.: 12/245,912

(22) Filed: Oct. 6, 2008

(51) Int. Cl. G06F 15/16

(52) U.S. Cl. 709/206

(57) ABSTRACT

A method and computer program product for defining a main email thread having a main thread distribution list defining one or more main email thread participants. One or more email messages may be associated with the main email thread. A sub email thread may be defined based upon, at least in part, the main email thread. The sub email thread may have a sub distribution list defining one or more sub email thread participants. The one or more sub email thread participants may include one or more of the main email thread participants. One or more email messages may be associated with the sub email thread.

### TECHNICAL FIELD

This disclosure relates to email systems, and more particularly to email systems that allow for the management of email threads and sub threads.

### BACKGROUND

In the present internet and electronic communication age, email is an increasingly prevalent means of communication, especially mass communication, because email allows the same message to be easily sent to a large group of people. Email communications systems may enable users to begin an email thread from which some of the users may start a sub thread related to the original thread. Unfortunately, such communication systems do not provide the functionality to manage the sub threads that have spun-off from the original thread.

### SUMMARY OF THE DISCLOSURE

In a first implementation, a method includes defining a main email thread having a main thread distribution list defining one or more main email thread participants. One or more email messages may be associated with the main email thread. A sub email thread may be defined based upon, at least in part, the main email thread. The sub email thread may have a sub distribution list defining one or more sub email thread participants. The one or more sub email thread participants may include one or more of the main email thread participants. One or more email messages may be associated with the sub email thread.

One or more of the following features may be included. At least a portion of the one or more main email thread participants may be notified of an initiation of the sub email thread. One or more main email thread participants may be invited to participate in the sub email thread. One or more sub email thread participants may be enabled to invite additional users to participate in the sub email thread. Access to one or more of the main email thread and the sub email thread may be restricted. One or more of the sub email thread participants may be enabled to unsubscribe from the sub email thread.

One or more of the email messages associated with the sub email thread may be merged into the main email thread. One or more of the sub email thread participants may be allowed to close the sub email thread. A main email thread moderator may be allowed to close the sub email thread. The sub email thread may be established as a new email thread and the new email thread may be separated from the main email thread.

According to another implementation, a computer program product resides on a computer readable medium, having a plurality of instructions stored on it. When executed by a processor, the instructions cause the processor to perform operations including defining a main email thread having a main thread distribution list defining one or more main email thread participants. The instructions further cause the processor to associate one or more email messages with the main email thread. A sub email thread may be defined based upon, at least in part, the main email thread. The sub email thread may have a sub distribution list defining one or more sub email thread participants. The one or more sub email thread participants may include one or more of the main email thread participants. The instructions further cause the processor to associate one or more email messages with the sub email thread.

One or more of the following features may be included. The instructions may further cause the processor to notify at least a portion of the one or more main email thread participants of an initiation of the sub email thread. One or more main email thread participants may be invited to participate in the sub email thread. The instructions further cause the processor to enable one or more sub email thread participants to invite additional users to participate in the sub email thread. Access to one or more of the main email thread and the sub email thread may be restricted. The instructions may further cause the processor to enable one or more of the sub email thread participants to unsubscribe from the sub email thread.

One or more of the email messages associated with the sub email thread may be merged into the main email thread. One or more of the sub email thread participants may be allowed to close the sub email thread. A main email thread moderator may be allowed to close the sub email thread. The sub email thread may be established as a new email thread and the new email thread may be separated from the main email thread.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an email thread management process and an email server application coupled to a distributed computing network;

FIG. 2 is a diagrammatic view of an email thread management process of FIG. 1;

FIG. 3 is a flowchart of a process executed by the email thread management process of FIG. 1; and

FIG. 4 is a diagrammatic view of a plurality of email threads managed by the email thread management process of FIG. 1.

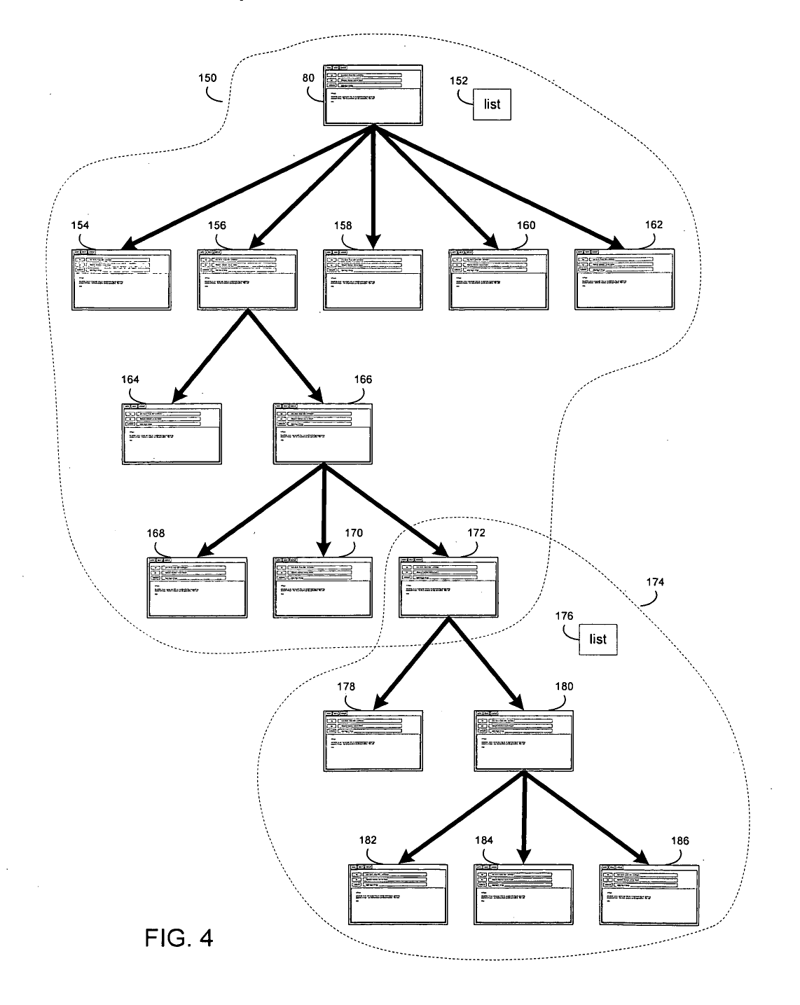

Like reference symbols in the various drawings indicate like elements.

### DETAILED DESCRIPTION

### System Overview

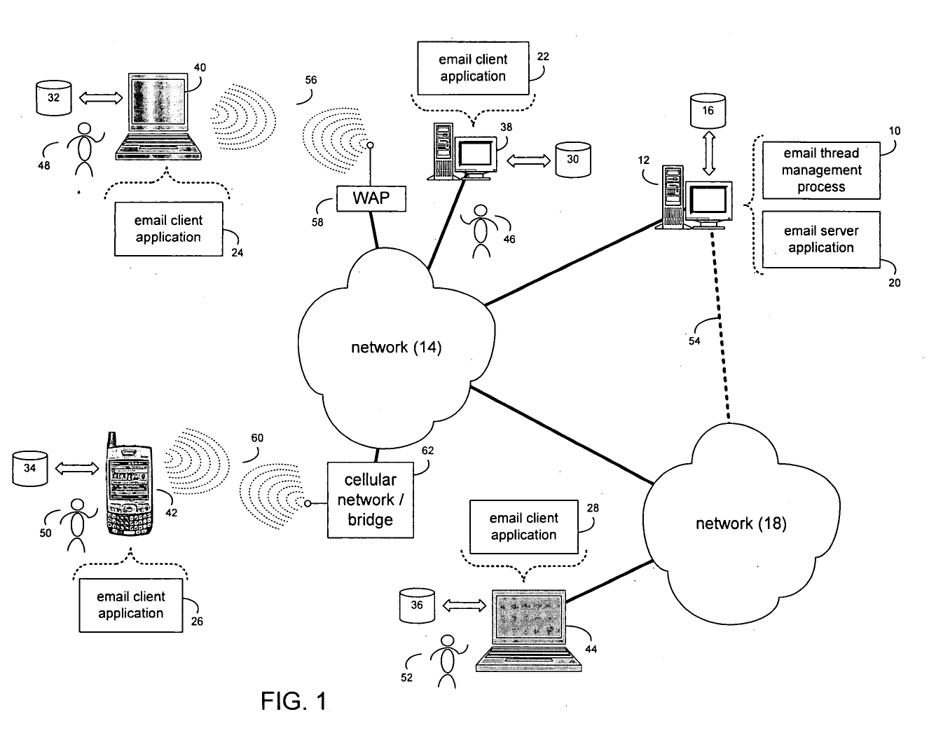

Referring to FIG. 1, there is shown email thread management process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the email thread management process may reside on a client electronic device, such as a personal computer, a notebook computer, a personal digital assistant, or the like.

As will be discussed below in greater detail, email thread management process 10 may define a main email thread having a main thread distribution list defining one or more main email thread participants. One or more email messages may be associated with the main email thread. A sub email thread may be defined based upon, at least in part, the main email thread. The sub email thread may have a sub distribution list defining one or more sub email thread participants. The one or more sub email thread participants may include one or more of the main email thread participants. One or more email messages may be associated with the sub email thread.

The instruction sets and subroutines of email thread management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more email server applications (e.g., email server application 20), examples of which may include but are not limited to, e.g., Lotus Domino ™ Server and Microsoft Exchange™ Server. Email server application 20 may interact with one or more email client applications (e.g., email client applications 22, 24, 26, 28) for routing and managing email communications. Examples of email client applications 22, 24, 26, 28 may include, but are not limited to, e.g., Lotus Notes™ and Microsoft Outlook™. Email thread management process 10 may be a stand-alone application that interfaces with email server application 20 or may be an applet/application that is executed within email server application 20.

The instruction sets and subroutines of email server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the email thread management process may be a client-side application (not shown) stored on a storage device (e.g., storage device 30, 32, 34, 36) coupled to a client electronic device (e.g., client electronic device 38, 40, 42, 44), respectively. As such, the email thread management process may be a stand-alone application that interfaces with an email client application (e.g., email client application 22, 24, 26, 28), or may be an applet/application that is executed within the email client application. As such, the email thread management process may be a client-side process (i.e., executed essentially exclusively on a client electronic device, such as client electronic device 38, 40, 42, 44), a server-side process (i.e., executed essentially exclusively on server computer 12), or a hybrid client-side/server-side process (i.e., executed partially on server computer 12 and executed partially on one or more of client electronic devices 38, 40, 42, 44.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown). Using email client applications 22, 24, 26, 28, users 46, 48, 50, 52 (respectively) may e.g., send, receive, and manage email communications, which may include accessing and/or interacting with email server application 20.

Users 46, 48, 50, 52 may access email server application 20 directly through the device on which the email client application (e.g., email client application 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with link line 54 (shown in phantom).

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Email Thread Management Process

For illustrative purposes email client application 22 will be discussed. However, this should not be construed as a limitation of the present disclosure, as other email client applications (e.g., email client applications 24, 26, 28) may be equally utilized.

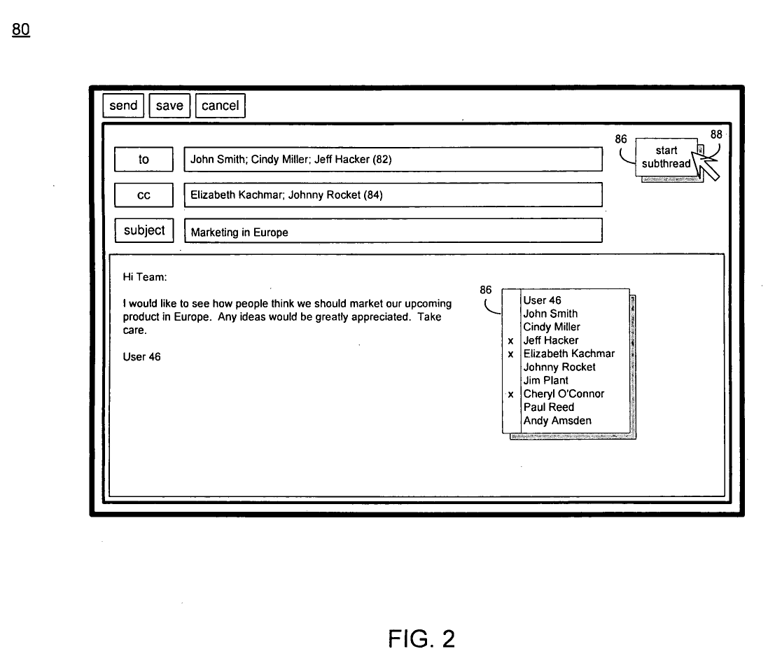

Referring also to FIG. 2, via email client application 22, user 46 may compose an email message (e.g., email message 80) concerning e.g., plans for marketing a new product in Europe) that is transmitted to a plurality of intended recipients. As is known in the art, recipients of email message 80 may be defined within “TO” field 82 of email message 80, “CC” field 84 of email message 80, and BCC field (not shown) of email message 80. Email client application 22 (alone or in combination with email thread management process 10 and/or email server application 20) may enable user 46 to send email message 80 to the above-described intended recipients. Accordingly, via email client application 22 (alone or in combination with email thread management process 10 and/or email server application 20), user 46 may send email message 80 to “John Smith”, “Cindy Miller” and “Jeff Hacker” (as defined within “TO” field 82 of email message 80), and “Elizabeth Kachmar” and “Johnny Rocket” (as defined within “CC” field 84 of email message 80).

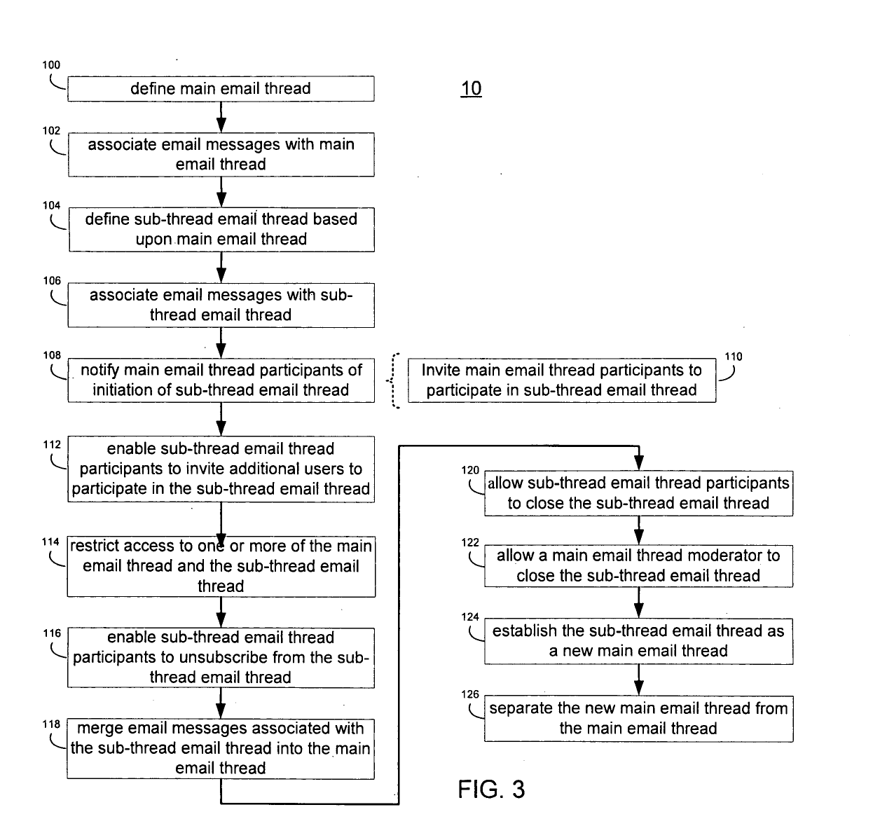

Referring also to FIG. 3 & 4, email thread management process 10 may define 100 main email thread 150 for email message 80. For example, assuming that email message 80 is a newly-composed email message (as opposed to a forward/reply of any earlier composed email message), email message 80 represents a new email-based discussion and, therefore, email thread management process 10 may define 100 main email thread 150 for email message 80. Main email thread 150 for email message 80 (as defined by email thread management process 10) may include main thread distribution list 152 that defines one or more main email thread participants. Depending on the manner in which email thread management process 10 is configured, the composer of email message 80 (i.e., user 46) may also be included within main thread distribution list 152.

As used in this disclosure, main email thread 150 may refer to a family of email messages that all originate from a common source (e.g., email message 80 and any downstream responses/forwards concerning the specific email message). For example and for illustrative purposes, assume that user 46 sends email message 80 to the above-described five recipients (i.e., “John Smith”, “Cindy Miller”, “Jeff Hacker”, “Elizabeth Kachmar”, and “Johnny Rocket”), resulting in the transmission of five email messages, namely email messages 154, 156, 158, 160, 162 (respectively). Accordingly and for this example, email thread management process 10 may define main thread distribution list 152 to include “John Smith”, “Cindy Miller”, “Jeff Hacker”, “Elizabeth Kachmar”, “Johnny Rocket” and user 46 (i.e., the main email thread participants).

Email thread management process 10 (alone or in combination with email client application 22 and/or email server application 20) may associate 102 email messages with main email thread 150. Accordingly and continuing with the above-stated example, email thread management process 10 may associate 102 email message 80, 154, 156, 158, 160, 162 with main email thread 150.

Further and for illustrative purposes, assume that “Cindy Miller” forwards email message 156 to “Paul Reed” (resulting in the generation of email message 164) and “Andy Amsden” (resulting in the generation of email message 166), in which the above-described five original recipients (i.e., “John Smith”, “Cindy Miller”, “Jeff Hacker”, “Elizabeth Kachmar”, and “Johnny Rocket”) are CC'd. Accordingly, email thread management process 10 may update main thread distribution list 152 to include “Paul Reed” and “Andy Amsden” (in addition to “John Smith”, “Cindy Miller”, “Jeff Hacker”, “Elizabeth Kachmar”, and “Johnny Rocket”),

Further and continuing with the above stated example, assume that “Andy Amsden” replies to user 46 (resulting in the generation of email message 168), while CCing (i.e., “John Smith”, “Cindy Miller”, “Jeff Hacker”, “Elizabeth Kachmar”, “Johnny Rocket” and “Paul Reed”). Further, assume that “Andy Amsden” forwards email message 156 to “Jim Plant” (resulting in the generation of email message 170) and “Cheryl O'Connor” (resulting in the generation of email message 172), in which “John Smith”, “Cindy Miller”, “Jeff Hacker”, “Elizabeth Kachmar”, “Johnny Rocket”, “Paul Reed” and “Andy Amsden” are CC'd. Accordingly, email thread management process 10 may update main thread distribution list 152 to include “Jim Plant” and “Cheryl O'Connor” (in addition to “Paul Reed”, “Andy Amsden”, “John Smith”, “Cindy Miller”, “Jeff Hacker”, “Elizabeth Kachmar”, and “Johnny Rocket”). Further, email thread management process 10 may associate 102 email messages 168, 170, 172 with main email thread 150.

Email thread management process 10 (alone or in combination with email client application 22 and/or email server application 20) may define 104 a sub email thread (e.g., sub email thread 174) that is based, at least in part, upon main email thread 150 (e.g., sub email thread 174 may be related to the subject matter of main email thread 150). Specifically, email thread management process 10 may enable a user/administrator/moderator of email server application 20 to define 104 various email messages as sub email thread 174, which is based upon main email thread 150.

Continuing with the above-described example in which main email thread 150 concerns plans for marketing a new product in Europe, assume that “Cheryl O'Connor” (i.e., the recipient of email message 172) is the European Marketing Agent for Ireland and may wish to focus the discussion on any special challenges associated with marketing the product in Ireland. Accordingly, “Cheryl O'Connor” may select “start subthread” button 86 via onscreen pointer 88, which is controllable by a pointing device (e.g., a mouse; not shown) coupled to a client electronic device (e.g., client electronic device 42), thus allowing the discussion concerning the marketing of the product in Ireland to be spun off from the discussion regarding Europe in general.

Similar to main email thread 150, sub email thread 174 may include sub distribution list 176 that defines one or more sub email thread participants, which may include one or more of the main email thread participants. For example and as discussed above, main thread distribution list 152 may identify User 46, “Jim Plant”, “Cheryl O'Connor”, “Paul Reed”, “Andy Amsden”, “John Smith”, “Cindy Miller”, “Jeff Hacker”, “Elizabeth Kachmar”, and “Johnny Rocket”.

When email thread management process 10 defines 104 sub email thread 174, email thread management process 10 may render popup window 86 that allows e.g., “Cheryl O'Connor” to define 10 sub distribution list 176. Popup window 86 maybe initially populated with the names included within main thread distribution list 152, namely User 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden”.

Accordingly and via onscreen pointer 88, “Cheryl O'Connor” may select one or more of “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden” to be included within sub distribution list 176. Additionally, thread management process 10 may be configured to allow “Cheryl O'Connor” to select additional participants who are not members of main thread distribution list 152 for inclusion within sub distribution list 176. Assume for illustrative purposes that “Cheryl O'Connor” selects “Jeff Hacker” and “Elizabeth Kachmar” for inclusion within sub distribution list 176 (in addition to “Cheryl O'Connor” which is selected by default as the definer of sub email thread 174).

Email thread management process 10 (alone or in combination with email client application 22 and/or email server application 20) may associate 106 one or more email messages with sub email thread 174. Assume for illustrative purposes that “Cheryl O'Connor” forwards email message 172 to “Jeff Hacker” (resulting in email message 178) and “Elizabeth Kachmar” (resulting in email message 180).

Continuing with the above-stated example, email thread management process 10 may associate 106 email message 172 (i.e., the original email message from which sub email thread 174 was initiated), as well as email message 178 and email message 180 with sub email thread 174. Additionally, email thread management process 10 may associate 106 subsequent email messages (e.g., responses to or forwards of email message 172, email message 178 and email message 180) with sub email thread 174.

Email thread management process 10 (alone or in combination with email client application 22 and/or email server application 20) may notify 108 at least a portion of the participants of main thread distribution list 152 (namely User 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden”) of the initiation of sub email thread 174. For example, when sub email thread 174 was defined 104 (i.e., initiated by “Cheryl O'Connor”), email thread management process 10 may notify 108 one or more of user 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden” of the initiation of sub email thread 174 by e.g. sending one or more of them a notification email message, explaining that sub email thread 174 was defined 104.

Continuing with the above-stated example in which “Cheryl O'Connor” selects “Jeff Hacker” and “Elizabeth Kachmar” for inclusion within sub distribution list 176, email thread management process 10 may send a notification email message to “Jeff Hacker” and “Elizabeth Kachmar”, notifying 108 “Jeff Hacker” and “Elizabeth Kachmar” that sub email thread 174 was defined 104 and initiated by “Cheryl O'Connor”. Depending on the manner in which thread management process 10 is configured, thread management process 10 may also notify the participants of main thread distribution list 152 who were not selected by “Cheryl O'Connor”, namely User 46, “John Smith”, “Cindy Miller”, “Johnny Rocket” “Jim Plant”, “Paul Reed”, and “Andy Amsden”.

Further, email thread management process 10 (alone or in combination with email client application 22 and/or email server application 20) may invite 110 “Jeff Hacker” and “Elizabeth Kachmar” to participate in sub email thread 174. When email thread management process 10 invites 110 “Jeff Hacker” and “Elizabeth Kachmar” to participate in sub email thread 174, email thread management process 10 may send a separate email message to “Jeff Hacker” and “Elizabeth Kachmar”, or the invitation to participate in sub email thread 174 may be included within the notification email message sent to “Jeff Hacker” and “Elizabeth Kachmar”, notifying 108 them that sub email thread 174 was defined 104 and initiated by “Cheryl O'Connor”.

Email thread management process 10 may be configured (alone or in combination with email client application 22 and/or email server application 20) to enable 112 one or more sub email thread participants (e.g., “Jeff Hacker” and “Elizabeth Kachmar”) to invite additional users to participate in sub email thread 174. Continuing with the above-stated example, email thread management process 10 may enable 112 “Jeff Hacker” and “Elizabeth Kachmar” to invite one or more of e.g., User 46, “John Smith”, “Cindy Miller”, “Johnny Rocket” “Jim Plant”, “Paul Reed”, and “Andy Amsden” to participate in sub email thread 174. The additional participants may be invited e.g., by sending an email message or by adding the additional participants to sub distribution list 176 via e.g., popup window 86. Additionally, email thread management process 10 may be configured to enable 112 “Jeff Hacker” and “Elizabeth Kachmar” to invite additional participants who are not members of main thread distribution list 152 (e.g., an Irish colleague who might have additional insight into marketing a product in Ireland but who did not participate in main email thread 150).

Additionally, email thread management process 10 (alone or in combination with email client application 22 and/or email server application 20) may restrict 114 access to one or more of main email thread 150 and sub email thread 174. For example, the ability to participate in and to invite others to participate in a mail thread may be limited to a predefined list of participants, or may be controlled by a moderator, an administrator or the originator of the email thread (e.g., main email thread 150 and/or sub email thread 174). The moderator may be an email moderator and the administrator may be an email system administrator. For example, participants in main email thread 150 may be restricted 114 to only those deemed acceptable by user 46. Further, participants in sub email thread 174 may be restricted 114 to only those deemed acceptable by “Cheryl O'Connor”.

Email thread management process 10 (alone or in combination with email client application 22 and/or email server application 20) may enable 116 one or more of the sub email thread participants to unsubscribe from sub email thread 174. For example, a user who does not wish to participate in sub email thread 174 may elect to be removed from sub email thread distribution list 176 and, thereby, to no longer receive email messages relating to sub email thread 174. Continuing with the above-stated example, if “Jeff Hacker” had no knowledge of marketing a product in Ireland, email thread management process 10 may enable 116 “Jeff Hacker” to elect not to receive any more email messages relating to sub email thread 174.

Continuing with the above-stated example, assume for illustrative purposes that “Elizabeth Kachmar” forwards email message 180 to “Johnny Rocket” (resulting in email message 182), “Jim Plant” (resulting in email message 184) and “Paul Reed” (resulting in email message 186). Email thread management process 10 may update sub thread distribution list 176 to include “Johnny Rocket” “Jim Plant” and “Paul Reed”.

Email thread management process 10 (alone or in combination with email client application 22 and/or email server application 20) may allow for the merger 118 of one or more of the email messages associated with sub email thread 174 into main email thread 150. For example, an email message (e.g., email message 186) within sub email thread 174 that discusses the broader main email thread topic (i.e., marketing a new product in Europe) may be merged 118 into the main email thread 150 by e.g., copying the names included within main thread distribution list 152 (e.g., User 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden”). Alternatively, email message 186 may be forwarded to the names included within main thread distribution list 152, namely User 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden”. Accordingly, if email message 186 includes discussions of marketing the product in Ireland (with respect to marketing the product in Europe), email message 186 may be merged 118 with main email thread 150, thus enabling main email thread participants (e.g., User 46, “John Smith”, “Cindy Miller”, “Jeff Hacker”, “Elizabeth Kachmar”, “Johnny Rocket” “Jim Plant”, “Cheryl O'Connor”, “Paul Reed”, and “Andy Amsden”) to consider and/or contribute to the discussion presented in email message 186.

Email thread management process 10 (alone or in combination with email client application 22 and/or email server application 20) may allow 120 one or more of the one or more sub email thread participants identified within sub distribution list 176 to close sub email thread 174. Accordingly, if meaningful discussions within sub email thread 174 have ended (or is otherwise no longer necessary), email thread management process 10 may allow 120 e.g., “Elizabeth Kachmar” to end/close sub email thread 174 and/or disable further replies to any of the email messages associated with sub email thread 174.

Additionally/alternatively, email thread management process 10 (alone or in combination with email client application 22 and/or email server application 20) may be configured to allow 122 a moderator of main email thread 150 to close sub email thread 174. Similar to the above, if meaningful discussions within sub email thread 174 have ended (or is otherwise no longer necessary), email thread management process 10 may allow 122 a moderator of main email thread 150 to end/close sub email thread 174 and/or disable further replies to any of the email messages associated with sub email thread 174.

Further, email thread management process 10 (alone or in combination with email client application 22 and/or email server application 20) may establish 124 sub email thread 174 as a new (i.e., independent) email thread and this new (i.e., independent) email thread may be separated 126 from main email thread 150. For example, if sub email thread 174 has spun off into a discussion (e.g., great vacation spots within Ireland) that is now unrelated to the original discussion (e.g., plans for marketing a new product in Europe) of main email thread 150, email thread management process 10 may establish 124 sub email thread 174 as a new and independent email thread. Email thread management process 10 may then separate the new main email thread (i.e., old sub email thread 174) from main email thread 150 by e.g., creating a different title and/or distribution list for the new email thread.

A number of implementations have been described. Nevertheless, it will be understood that various modifications may be made. Accordingly, other implementations are within the scope of the following claims.

What is claimed is:

1. A method comprising:
defining a main email thread having a main thread distribution list defining one or more main email thread participants;
associating one or more email messages with the main email thread;
defining a sub email thread based upon, at least in part, the main email thread, the sub email thread having a sub distribution list defining one or more sub email thread participants, the one or more sub email thread participants including one or more of the main email thread participants; and
associating one or more email messages with the sub email thread.

2. The method of claim 1, further comprising:
notifying at least a portion of the one or more main email thread participants of an initiation of the sub email thread.

3. The method of claim 2, wherein notifying at least a portion of the one or more main email thread participants of the initiation of the sub email thread includes:
inviting one or more main email thread participants to participate in the sub email thread.

4. The method of claim 1, further comprising:
enabling one or more sub email thread participants to invite additional users to participate in the sub email thread.

5. The method of claim 1, further comprising:
restricting access to one or more of the main email thread and the sub email thread.

6. The method of claim 1, further comprising:
enabling the one or more of the sub email thread participants to unsubscribe from the sub email thread.

7. The method of claim 1, further comprising:
merging one or more of the email messages associated with the sub email thread into the main email thread.

8. The method of claim 1, further comprising:
allowing one or more of the sub email thread participants to close the sub email thread.

9. The method of claim 1, further comprising:
allowing a main email thread moderator to close the sub email thread.

10. The method of claim 1, further comprising:
establishing the sub email thread as a new email thread; and
separating the new email thread from the main email thread.

11. A computer program product residing on a computer readable medium having a plurality of instructions stored thereon which, when executed by a processor, cause the processor to perform operations comprising:
defining a main email thread having a main thread distribution list defining one or more main email thread participants;
associating one or more email messages with the main email thread;
defining a sub email thread based upon, at least in part, the main email thread, the sub email thread having a sub distribution list defining one or more sub email thread participants, the one or more sub email thread participants including one or more of the main email thread participants; and
associating one or more email messages with the sub email thread.

12. The computer program product of claim 11, further comprising instructions for:
notifying at least a portion of the one or more main email thread participants of an initiation of the sub email thread.

13. The computer program product of claim 12, wherein the instructions for notifying at least a portion of the one or more main email thread participants of the initiation of the sub email thread include instructions for:
inviting one or more main email thread participants to participate in the sub email thread.

14. The computer program product of claim 11, further comprising instructions for:
enabling one or more sub email thread participants to invite additional users to participate in the sub email thread.

15. The computer program product of claim 11, further comprising instructions for:
restricting access to one or more of the main email thread and the sub email thread.

16. The computer program product of claim 11, further comprising instructions for:
enabling the one or more of the sub email thread participants to unsubscribe from the sub email thread.

17. The computer program product of claim 11, further comprising instructions for:
merging one or more of the email messages associated with the sub email thread into the main email thread.

18. The computer program product of claim 11, further comprising instructions for:
allowing one or more of the sub email thread participants to close the sub email thread.

19. The computer program product of claim 11, further comprising instructions for:
allowing a main email thread moderator to close the sub email thread.

20. The computer program product of claim 11, further comprising instructions for:
establishing the sub email thread as a new email thread; and
separating the new email thread from the main email thread.
